(19) United States
(12) Patent Application Publication
(10) Pub. No.: US 2026/0307247 A1
(43) Pub. Date: Oct. 8, 2026

(54) SYSTEM(S) AND METHOD(S) OF USING BEHAVIORAL CLONING VALUE APPROXIMATION IN TRAINING AND REFINING ROBOTIC CONTROL POLICIES

(71) Applicant: GDM Holding LLC, Mountain View, CA (US)

(72) Inventors: Daniel Ho, Fremont, CA (US); Seyed Mohammad Khansari Zadeh, San Carlos, CA (US); Cem Gokmen, Mountain View, CA (US)

(21) Appl. No.: 19/107,481

(22) PCT Filed: Sep. 15, 2023
(86) PCT No.: PCT/US2023/032900

§ 371 Date: Feb. 27, 2025

Related U.S. Application Data
(60) Provisional application No. 63/407,134, filed on Sep. 15, 2022.
(60) Provisional application No. 63/408,714, filed on Sep. 21, 2022.

(51) Int. Cl. B25J 9/16

(52) U.S. Cl. CPC B25J 9/1653; B25J 9/163; B25J 9/1697

(57) ABSTRACT

Implementations described herein relate to training and refining failure neural network (NN) models and robotic control policies using imitation learning techniques. A failure NN model and a robotic control policy can initially be trained based on human demonstrations of various robotic tasks. In many implementations, an instance of vision data capturing the environment of the robot can be processed using an embedding model to generate an embedding. The given embedding can be processed using the failure NN model to generate failure output indicating the likelihood of the robot failing to complete the robotic task. In various implementations, the given embedding can also be processed using the robotic control policy to generate action output for use in controlling the robot in performance of the robotic task.

### BACKGROUND

Various techniques have been proposed to enable robots to perform various real-world tasks. For example, some techniques employ imitation learning to train robotic control policies that are utilized in controlling robots to perform these tasks. In imitation learning, these robotic control policies can be initially trained based on data from a plurality of human demonstrations of these tasks. For instance, a human may physically manipulate a given robot, or an end effector thereof, to cause a reference point of the given robot or the end effector to traverse the particular trajectory- and that particular traversed trajectory may thereafter be repeatable by using a robotic control policy trained based on the physical manipulation by the human. Also, for instance, the human may control a given robot, or end effector thereof, using one or more teleoperation techniques to perform a given task, and the given task may thereafter be repeatable by using a robotic control policy trained based on one or more of the teleoperation techniques.

### SUMMARY

Implementations disclosed herein are directed towards determining a failure output indicating the likelihood a robot will fail in performance of a robotic task. Such robotic task(s) can include, for example, door opening, door closing, drawer opening, drawer closing, picking up an object, placing an object, and/or other robotic task(s). In some implementations, the failure output can indicate the likelihood the robot will fail in performance of the robotic task at some point in the future. In some implementations, the system can determine to request for a human operator to intervene in the robot's performance of the task, where the determination to request the human intervention can be based on the failure output. Some implementations relate to training a failure neural network (NN) model to generate the failure output.

In some implementations, vision data can capture the environment of a robot during the performance of a robotic task by the robot. For example, vision data can capture the environment of a robot while the robot performs the task of picking up a cup. In some implementations, an instance of vision data capturing the state of the robot performing the task can be processed using an embedding model to generate an embedding. In some of those implementations, the embedding can be processed using a robotic control policy to generate action output corresponding to an action to be performed by the robot in continuance of the performance of the task. In some implementations, the action output can indicate corresponding action for one or more components of the robot. For example, the components of the robot can include a robot base, a robot arm, a robot end effector, and/or one or more additional or alternative robotic components. The action output can indicate an action for each of the one or more components.

Additionally or alternatively, the embedding can be processed using the failure NN model to generate the failure output. In other words, the same embedding processed using the robotic control policy to generate the action output can be processed using the failure NN model to generate the failure output.

In some implementations, the system can determine whether the robot will fail in performance of the robotic task based on the failure output. For example, the system can determine the robot will fail the task if the failure output satisfies a threshold value. For example, the system can determine the robot will fail the task if the failure output exceeds 75 percent, 80 percent, 90 percent, and/or one or more additional or alternative values.

In some implementations, the system can determine whether the failure output has exceeded a threshold value for several states. In other words, the failure output can indicate the robot will fail the task when the failure output corresponding to the state and one or more previous failure outputs corresponding to one or more previous states are above a threshold value. For example, the system can determine the robot will fail the task if the failure output exceeds a threshold value for two states, three sequential states, three of the last five states, five total states, five sequential states, and/or additional or alternative combinations of previous states.

Additionally or alternatively, the system can determine whether the robot will fail the task based on multiple threshold values. In some of those implementations, the system can determine the robot will the fail the task if the failure output exceeds a given threshold value or if the failure output exceeds an additional threshold value for multiple states. For example, the system can determine the robot will fail the task if the failure output ever exceeds a threshold value (e.g., 95%) or if the failure output corresponding to sequence of states exceeds an additional threshold value (e.g., three sequential states have a corresponding failure output that exceeds 75%). In other words, the system can determine the robot will fail the task if any individual failure output indicates such a high likelihood the robot will fail, or if several failure outputs indicate a lower likelihood the robot will fail.

In some implementations, the system can determine the status of availability of computing devices to intervene in robotic task performance when selecting a particular threshold value. Additionally or alternatively, the system can select a particular threshold value based on the robotic task and/or category of robotic task being performed. For example, the system can select a particular threshold value when the robot is performing grasping tasks, and the system can select an additional particular threshold value when the robot is performing locomotion tasks.

In some implementations, the system can select the particular threshold based on whether the robot has detected one or more particular types of objects in the environment. The one or more objects can include obstacle(s) for the robot to avoid while performing the task (e.g., a wall, a table, a door, a shelf, another robot, a human, one or more additional or alternative obstacles, and/or combinations thereof) as well as objects used by the robot in performance of the task (e.g., a tool the robot picks up, an object to retrieve off a shelf, a door to close, one or more objects used in performance of the robotic task, and/or combinations thereof). For example, the system can select the particular threshold based on determining whether the robot has detected a door in the environment. Additionally or alternatively, the system can select a particular threshold based on whether one or more objects are within a threshold distance of the robot.

Accordingly, various implementations set forth techniques for predicting a future failure of a robot to complete a robotic task. By predicting future failures, the robot can request help from a human operator to complete the task. In some of those implementations, instructions to complete the task provided by the human operator can be used as additional training data to further refine the policy network and/or failure NN of the system. Additionally or alternatively, the robot can pause execution of the task as soon as it determines a predicted failure instead of waiting to detect a failure after it has occurred. In some cases, the robot can be damaged by the task failure (e.g., the robot can fall resulting in damage to one or more components of the robot and motors, gears, etc. can be damaged by attempting to perform an action the robot is not capable of performing). Stopping task execution prior to the failure can protect the robot from such damage. Additionally or alternatively, computing resources (e.g., processor cycles, memory, battery power, etc.) can be conserved by stopping the execution of the task when the failure is detected. In other words, the computing resources used from the point the future failure is predicted until the time the robot fails the task can be conserved.

The above description is provided only as an overview of some implementations disclosed herein. These and other implementations of the technology are disclosed in additional detail below.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

In some implementations, a method implemented by one or more processors is provided where the method includes receiving an instance of vision data capturing an environment of a robot during performance of a robotic task by the robot, where the instance of vision data is captured via a vision component. In some implementations, the method includes generating an embedding based on processing the instance of vision data using an encoder model, the encoder model being a trained neural network (NN) model. In some implementations, the method includes processing the embedding using a robotic control policy to generate action output that indicates, for each of one or more components of the robot, a corresponding action to be performed by the component, the robotic control policy being a trained NN model. In some implementations, the method includes processing the embedding using a failure NN model to generate failure output indicating a likelihood of the robot successfully completing the task. In some implementations, the method includes determining, based on the failure output, whether the robot will fail in performance of the robotic task. In some implementations, in response to determining the robot will fail in performance of the robotic task, the method includes causing a user of a computing device to intervene in performance of the robotic task. In some implementations, the method includes receiving, from the user and via the computing device, user interface input that intervenes with performance of the robotic task. In some implementations, the method includes causing the robot to complete performance of the task based on the user interface input.

These and other implementations of the technology can include one or more of the following features.

In some implementations, the robotic control policy is trained using imitation learning. In some versions of those implementations, the robotic control policy is a Behavior Cloning model.

In some implementations, determining whether the robot will fail in performance of the robotic task based on the failure output includes determining whether the failure output satisfies a threshold value.

In some implementations, determining whether the robot will fail in performance of the robotic task based on the failure output includes determining whether the failure output satisfies a threshold value. In some implementations, the method further includes determining whether a previous failure output satisfies the threshold value, wherein the previous failure output was generated by processing a previous embedding using the failure model, and wherein the previous embedding was generated based on processing a previous instance of vision data captured t by the vision component during the performance of the robotic task by the robot. In some implementations, the method further includes determining whether the robot will fail in performance of the robotic task based on both whether the failure output satisfies the threshold likelihood value and whether the previous failure output satisfies the threshold likelihood value. In some versions of those implementations, the previous instance of vision data is an immediately preceding instance of vision data, captured most recently by the vision component relative to the instance of vision data, and wherein the previous embedding, generated based on the previous instance of vision data, is utilized in determining whether the robot will fail in performance of the robotic task based on the previous instance of vision data being the immediately preceding instance of vision data. In some versions of those implementations, the previous instance of vision data is captured by the vision component within a threshold amount of time relative to the instance of vision data, and wherein the previous embedding, generated based on the previous instance of vision data, is utilized in determining whether the robot will fail in performance of the robotic task based on the previous instance of vision data being captured within the threshold amount of time.

In some implementations, the previous embedding was processed, using the robotic control policy to generate previous action output that indicated, for each of the plurality of components of the robot, a corresponding previous action to be performed by the component, and wherein the previous action was already implemented by the robot, or were being implemented by the robot, during processing the embedding using the failure NN model to generate the failure output.

In some implementations, determining whether the robot will fail in performance of the robotic task based on both whether the failure output satisfies the threshold likelihood value and whether the previous failure output satisfies the threshold likelihood value includes determining that the robot will not fail in performance of the task if either one of the failure output or the previous failure output fails to satisfy the threshold.

In some implementations, determining whether the robot will fail in performance of the robotic task based on both whether the failure output satisfies the threshold likelihood value and whether the previous failure output satisfies the threshold likelihood value includes determining that the robot will fail in performance of the task only when both the failure output or the previous failure output satisfy the threshold.

In some implementations, determining whether the robot will fail in performance of the robotic task based on the failure output includes selecting, from a plurality of candidate thresholds, a particular threshold. In some implementations, the method further includes determining whether the failure output satisfies the selected particular threshold. In some implementations, the method further includes determining whether the robot will fail in performance of the robotic task based on whether the failure output satisfies the selected particular threshold. In some versions of those implementations, selecting the particular threshold includes determining a current status of availability of computing devices to intervene in robotic task performance. In some implementations, the method further includes selecting the particular threshold based on the current status.

In some implementations, selecting the particular threshold includes selecting the particular threshold based on a category assigned to the robotic task that is being performed.

In some implementations, selecting the particular threshold includes selecting the particular threshold based on whether the robot has detected one or more particular types of objects in the environment.

In some implementations, selecting the particular threshold includes selecting the particular threshold based on whether the robot has detected one or more particular types of objects to be within a threshold distance of the robot.

In some implementations, the computing device is in the environment of the robot.

In some implementations, the computing device is remote from the robot and is not in the environment of the robot.

In some implementations, the method further includes causing the robotic control policy and/or the failure NN model to be updated based on the performance of the task based on the user interface input.

In some implementations, the failure NN model was previously trained based on a plurality of supervised training instances from a previous episode of robotic performance of a task that was determined to be a failure. In some versions of those implementations, each of the supervised training instances includes training instance input of a corresponding embedding, the corresponding embedding being generated during the episode using the encoder model and being processed, using the robotic control policy during the episode, to generate corresponding actions implemented during the episode, and training instance output that includes a corresponding failure measure. In some versions of those implementations, a plurality of the corresponding failure measures are discounted and indicate a corresponding reduced degree of failure. In some versions of those implementations, a given failure measure, of the corresponding failure measures, and of a given training instance, of the supervised training instances, is generated based on temporal separation between a first time corresponding to generation of the corresponding embedding of the given training instance and a second time corresponding to the failure. In some versions of those implementations, a given training instance of the training instances includes: a given embedding, of the corresponding embeddings, that was generated based on a first vision data instance of the episode, and a given failure measure, of the corresponding failure measures, that was generated based on a difference between the first vision data instance and a failure vision data instance, of the episode, that corresponds to the failure. In some versions of those implementations, a given training instance of the training instances includes: a given embedding, of the corresponding embeddings, that was generated at a first time of the episode, and a given failure measure, of the corresponding failure measures, that was generated based on a difference between a robot state at the first time and an alternate robot state at a failure time corresponding to the failure.

In some implementations, in response to determining that the robot will fail in performance of the robotic task: the method further includes halting performance of the task by the robot.

In some implementations, processing the embedding using the robotic control policy to generate the action output that indicates, for each of the one or more components of the robot, the corresponding action to be performed by the component, includes generating, as output of a first head of the model, a first portion of the action output, wherein the first portion of the action output indicates a first action to be performed by a first component of the robot. In some implementations, the method further includes generating, as output of a second head of the model, a second portion of the action output, wherein the second portion of the action output indicates a second action to be performed by a second component of the robot. In some versions of those implementations, the first component is a robot arm and the second component is a robot base.

In some implementations, a method implemented by one or more processors of a robot is provide, the method includes receiving an instance of vision data capturing an environment of the robot during performance of a robotic task by the robot, where the instance of vision data is captured via one or more vision components of the robot. In some implementations, the method includes generating an embedding based on processing the instance of vision data using an encoder model, the encoder model being a trained neural network (NN) model. In some implementations, the method includes processing the embedding using a robotic control policy to generate action output that indicates, for each of a plurality of components of the robot, a corresponding action to be performed by the component. In some implementations, the method includes processing the embedding using a failure NN model to generate failure output indicating a likelihood of the robot successfully completing the task. In some implementations, the method includes determining, based on the failure output, whether the robot will fail in performance of the robotic task. In some implementations, in response to determining that the robot will fail in performance of the robotic task, the method includes halting performance of the task by the robot. In some implementations, in response to determining that the robot will not fail in performance of the robotic task, the method includes continuing performance of the task by the robot, continuing performance of the task by the robot comprising causing implementation of the corresponding actions by the components of the robot.

These and other implementations of the technology can include one or more of the following features.

In some implementations, in response to determining that the robot will fail in performance of the robotic task, the method further includes causing a prompt to be rendered via an interface of a computing device or the robot, the prompt requesting intervention in performance of the robotic task. In some versions of those implementations, in response to determining that the robot will fail in performance of the robotic task, the method further includes transmitting, to a remote computing device, the vision data and/or additional vision data captured by at least one of the vision components. In some implementations, the method includes causing the robot to complete performance of the task based on user interface input received via the remote computing device responsive to the transmitting.

### BRIEF DESCRIPTION OF THE DRAWINGS

FIG. 1 illustrates an example environment in which implementations described herein can be implemented.

FIG. 2 is a block diagram illustrating an example of generating action output and failure output in accordance with various implementations described herein.

FIG. 3A-3D illustrate examples of determining whether failure output satisfies a threshold likelihood value in accordance with various implementations described herein.

FIG. 4A-4B is a flowchart illustrating an example process in accordance with various implementations described herein.

FIG. 5 schematically depicts an example architecture of a robot, in accordance with various implementations disclosed herein.

FIG. 6 schematically depicts an example architecture of a computer system, in accordance with various implementations disclosed herein.

### DETAILED DESCRIPTION

Recent progress in a variety of end-to-end Imitation Learning approaches have shown promising results and generalization capabilities on mobile manipulation tasks. Such models are seeing increasing deployment in real-world settings, where scaling up can require robots to be able to operate with high autonomy, i.e. requiring as little human supervision as possible. In order to avoid the need for one-on-one human supervision, robots need to be able to detect and prevent policy failures ahead of time. In some implementations, after detecting a policy failure, the robot can ask for help. In some of those implementations, multiple robots (e.g., a fleet of robots) asking for help when needed can allow a remote operator (e.g., a human operator) to supervise multiple robots and help when needed. However, the black-box nature of end-to-end Imitation Learning models such as Behavioral Cloning, as well as the lack of an explicit state-value representation, make it difficult to predict failures. Various implementations described herein include Behavioral Cloning Value Approximation (BCVA), an approach to learning a state value function based on and trained jointly with a Behavioral Cloning policy that can be used to predict failures. In some implementations, BCVA can be used to complete a variety of challenging mobile manipulation task such as (but not limited to) latched-door opening.

The field of robotics has seen significant developments in recent years on mobile manipulation tasks. A variety of techniques have made it possible to learn from simulated and real-world experiences together. Being able to fuse data from different sensor modalities, such as RGB and depth, has resulted in greatly improved action-taking decisions. Additionally or alternatively, fusing data from different sensor modalities can thus improve manipulation behaviors. With these improvements, it has become possible to deploy such mobile manipulation agents in the real world to solve practical real-life tasks. In this context, Imitation Learning (IL) approaches such as Behavioral Cloning have been established as a practical solution to many mobile manipulation tasks, such as latched door opening.

In some implementations, deploying Imitation Learning models in the real world can consist of two phases: a training phase where a human operator performs demonstrations in order to learn a policy, and an operational phase where the robot can operate, ideally unattended, in an open environment to perform its task. However, Imitation Learning approaches have some shortcomings that can make their naive implementation problematic for such real-world deployments. For example, agents trained using this paradigm tend to perform poorly in out-of-distribution states. Therefore, in the operational phase, the policy can continue to execute with compounding error under out-of-distribution states until failure can be externally detected post-factum, e.g. by a human operator, a sensor, etc., which can lead to damage to the robot and the environment. The need to prevent these catastrophic failures means the robots may need continuous one-on-one human supervision, blurring the lines between the training and operational phases.

One approach to this problem is to make sure as much of the robot's state space is covered by the training data as possible. In the training phase where one-on-one supervision is available, this can be achieved by applying data collection regimens, such as DAgger, that iteratively include more of the state space in the training distribution. However, even after applying DAgger, it is typically inevitable that the robot will encounter scenarios during deployment that it has not seen in training. In this case, it is desirable for the robot policy itself to be able to identify that it is going to be unable to solve the task successfully. In some implementations, the robot can preemptively stop and ask for help, potentially avoiding any damage to the robot and/or the environment based on allowing human experts to provide corrective demonstrations. In some implementations, this mode of operation can allow the robots to operate outside of one-on-one human-to-robot supervision, by allowing remote supervision where human operators at an off-site control center can loosely monitor multiple robots and intervene only when asked for help. In some implementations, this can allow retraining in the real world in an incremental manner: initial policies from the training phase are deployed on real robots, additional data is collected during the operational phase through both regular operations and expert corrections, and the policies are relearned periodically from the continuously-growing dataset.

In some implementations, the robot can quantify a confidence in its ability to solve the task given its current state in order to predict failure. While this role can be filled by a state-value function in the Reinforcement Learning paradigm, Behavioral Cloning does not provide an explicit value function representation. In some implementations, this gap can be filled by applying Reinforcement Learning approaches alongside Behavioral Cloning. In some of those implementations, Reinforcement Learning approaches alongside Behavioral Cloning for the purpose of obtaining a state-value representation, which comes at great computational cost and low data efficiency.

In some implementations, BCVA can be used to determine state-value representations, where the state-value representations are conditioned by a history of policies learned through incremental updates to the training data and the resulting evaluations from said policies. BCVA has three a variety of advantages: (1) BCVA can allow the state values to be batch-computed offline using policy evaluation data (and variable reward discounting regimes) prior to training, rather than through exploration in expensive paradigms such as Reinforcement Learning. (2) BCVA can be learned simply as a regression head on top of an existing Behavioral Cloning model, allowing for low-cost training and inference as well as weight sharing. (3) When trained jointly with the Behavioral Cloning model, BCVA can allow failure examples to also be used for representation learning, increasing the data available for learning a state embedding that helps the policy generalize better.

As an example, BCVA on a mobile manipulation robot can be used in solving the latched door opening task, where the robot must approach a closed latched door, grasp the handle and rotate it to release the latch, drive forward to open the door, and enter the room. This task is challenging due to the large number of failure modes that stem from minor errors, e.g., being unable to find or grasp the handle, grasping it too close to the pivot point to be able to apply the necessary force, or colliding with the door frame or the door itself.

The problem of Failure Detection and Prediction in robotics has received considerable interest in the past decades. The common theme of these existing techniques is that they are 1) policy-agnostic, in that they do not share weights or data with the robot policy, and 2) sensor-based, in that they use structured numeric data from a range of robot sensors to complete prediction, therefore avoiding the problem of representation learning on unstructured sensor data, e.g. images, as in our case. As a result, they are able to simply classify success/prediction from time series data as in our classification baseline with high success, an approach that does not transfer well to the more complex problem of in-the-wild failure detection from vision data.

In the context of Reinforcement Learning, asking for help and failure prediction can be achieved by thresholding based on policy-conditioned state values. To compute state values for a given policy (a task known as Policy Evaluation), a large variety of methods have been proposed. For example, Naive Policy Evaluation, which relies on generating rollouts of the given policy and using dynamic programming methods to propagate terminal rewards to intermediate states, can be used when it is possible to generate rollouts using the target policy. In the context of mobile manipulation, however, this can only be done in simulation, where most policies tend to perform much better than they do in reality due to the simulation-to-reality gap. Another branch of the literature, known as Off-Policy Policy Evaluation, focuses on the very relevant scenario of evaluating the performance of a new (target) policy using data collected using other (behavior) policies. However, these methods are difficult to apply in the context of Partially-Observable Markov Decision Processes (POMDPs) such as vision-based mobile manipulation since they largely rely on tabular data and the presence of explicit transition models, even if approximate, which makes them incompatible with Behavioral Cloning.

Similarly, the problem of detecting success/failure probabilities has been studied in the context of Imitation Learning policies. For example, Imitation Learning policies have been used in detecting out-of-distribution states to prevent robot failures. While these methods perform well in the task of detecting out-of-distribution scenarios, the detection of out-of-distribution scenarios itself does not necessarily constitute the most appropriate proxy task for error detection: many times, forward prediction can still be successfully performed under known failure conditions, and other times, high-entropy states (e.g. where objects are occluded or colliding etc.) where forward prediction is inherently difficult can show high reconstruction errors despite there being no failure. Additionally or alternatively, these methods also may not make use of existing evaluation data from previous behavior policies, a valuable stream of data in the context of iterative policy training. For example, a system can apply temporal difference-based Reinforcement Learning methods alongside Behavioral Cloning to learn explicit value functions for imitation-based policies. While effective, this approach is prohibitively costly in terms of computational and data efficiency, since it relies on generating and evaluating on-policy rollouts for the target policy.

A related problem in the context of Imitation Learning is Dataset Collection, i.e., how to collect the right demonstrations that allow a Behavioral Cloning policy to improve on failure scenarios with the highest possible data efficiency. To this end, DAgger is a well-tested mechanism that can be used at the time of data collection (in the training phase) to make sure that frequently-encountered but out-of-training-distribution states get new labelled data to help the policy recover from such states. However, the utility of DAgger in the case of mobile manipulation is limited, not only due to the high dimensionality of the state space and the low efficiency of collecting per-frame corrections from the experts, but also due to the simple fact that in a real-world deployment, many error scenarios will be encountered for the first time in the operational phase where the robots need to operate mostly unsupervised. In this context, even though corrective expert demonstrations can be collected post-failure, the DAgger strategy still relies on failing first and then learning to recover, rather than learning to stop prior to the failure. Furthermore, even when robots can be supervised continuously, when humans are instructed to preemptively stop the robot before failure, empirical evidence shows that they are inclined to intervene either too early (e.g. stopping a successful rollout because the robot's non-human embodiment makes the rollout feel unfamiliar) or too late (e.g. the robot quickly goes from an acceptable to a high-risk state without chance for intervention). Altogether, correcting naive imitation learning approaches with a DAgger-like strategy during deployment requires costly around-the-clock human operator monitoring, which nonetheless does not provide a simple and reliable mechanism for providing demonstrations to learn to avoid known failures.

In some implementations, given a mobile manipulation task, the system can jointly learn: (1) a policy π(a|s) that outputs an action a (e.g. a joint velocity) given a state s (e.g. RGB and depth images) in order to complete the task; and (2) a policy-conditioned state value function V_{π}(s) that assigns a higher value to states that have a higher probability of resulting in a successful rollout.

In some implementations, for learning the policy, the system can have a dataset

$${D}^{*} = \{ {τ}_{0}^{*} , {τ}_{1}^{*} , … , {τ}_{N}^{*} \}$$

consisting entirely of expert demonstrations τ*=(s₀, a₀, s₁, a₁, . . . , s_{T-1}, a_{T-1}, S_{T}) that result in successful completion of the task at state ST, with actions generated by an expert policy π*. In some of those implementations, the system can use Behavioral Cloning to learn to imitate this policy, where the objective is to minimize the divergence between our policy π(a|s) and the expert policy π*(a|s).

For learning the value function, it is necessary to also have trajectories of scenarios where the policy fails to complete the task. Various implementations include focusing on incremental robot learning scenarios where policies are periodically evaluated and re-learned using more training data. In some implementations, it can be assumed that the system starts with an initial policy π₀(a|s) trained on an initial dataset of demonstrations

$${D}_{0}^{*}$$

with no value estimate. A dataset of rollouts from the first policy then needs to be collected and labelled under full human supervision, and discounted returns computed offline to be used in bootstrapping the value estimate. Additionally or alternatively, each following policy πₖ(a|s) is trained jointly with a value estimate Vₖ(s) from previous episodes' labelled rollouts.

The policy is then deployed on a robot in the real world, where the robot repeatedly performs the task during daily operations, generating trajectories

$${τ}_{i}^{{π}_{k}} .$$

during operation are being recorded irrespective of whether or not the trajectory ends with a success (r=1) or failure (r=−1). Human operators are also allowed to provide additional expert demonstrations

$${D}_{k}^{*}$$

for failure cases and help requests by the robot. These demonstrations can then be added to the existing dataset to create the training set for the next policy

$${π}_{k + 1} : {D}_{k + 1} ⋃ {D}_{k}^{*} ⋃ \{ {τ}_{1}^{{π}_{k}} , {τ}_{2}^{{π}_{k}} , … , {τ}_{i}^{{π}_{k}} \} .$$

This dataset aggregation mechanism is described in detail in Algorithm 1 below.

```
D ← initial expert demonstrations;
π ← train(D);
while labelling for value bootstrapping contines do
  τ ← rollout(π);
  D ← D ∪ {τ};
end
while operational deployment continues do
  πV ← train(D);
  while operational cycle for π continues do
      τ ← rollout(π, V);
      D ← D ∪{τ};
      if τ includes an ask for help then
        ${τ}_{new}^{*} ← new expert demonstration ;$
        $D ← D ⋃ \{ {τ}_{new}^{*} \} ;$
      end
  end
end
```

In some implementations, given each state s; from trajectory τᵢ in the dataset Dₖ, the matching terminal reward rᵢ, and a discount factor γ accounting for how far in the future the reward is, the system can determine the discounted return function G(s) similar to that in Monte Carlo methods:

$${G}_{τ} ( {s}_{j} ) = {γ}^{{Δ}_{j}} {r}_{i} \qquad ( 1 )$$

where Δⱼ is the accumulated “distance” from sⱼ to the final state of the trajectory s_{|τ}_{ᵢ}_{|} using a distance function δ(sₐ, s_{b}):

$${Δ}_{i} = {\sum }_{j \leq t < \vert {τ}_{t} \vert} δ ( {s}_{t} , {s}_{t + 1} ) ) \qquad ( 2 )$$

In some implementations, a distance function is the time difference between two states (δ(sₐ, s_{b})=b−a), in which case the discounted reward is equivalent to the discounted reward in a Markov Decision Process:

$${G}_{τ} ( {s}_{j} ) = {γ}^{\vert {τ}_{t} \vert - j} {r}_{i} \qquad ( 3 )$$

Additional or alternative distance functions can be used in accordance with various implementations, such as (1) the normalized difference between the pixels in the input space, and (2) the normalized difference in the robot's kinematic state. For the pixel difference, the system can define distance function as the normalized sum of the absolute pixel differences:

$$δ ( {s}_{a} , {s}_{b} ) = \frac{( {\sum }_{x}^{w} {\sum }_{y}^{h} {\sum }_{c}^{C} \vert {s}_{b} ( x , y , c ) - {s}_{a} ( x , y , c ) \vert ) - \tilde{μ}}{\tilde{σ}} + 0.5 \qquad ( 4 )$$

where w is the RGB sensor width, h the RGB sensor height, C the number of channels, and sₜ(x, y, z) the value of the c′th channel of the pixel at (x, y) of state sₜ. The sample mean u and standard deviation \tilde{σ} are used to scale the values such that one standard deviation falls in the (0.5, 1.5) range, suitable for use as the discount factor exponent.

Similarly, the system can determine the kinematic state difference as the normalized sum of the joint states and robot base pose:

$$δ ( {s}_{a} , {s}_{b} ) = \frac{( {\sum }_{j ∈ J} \vert {s}_{b} ( j ) - {s}_{a} ( j ) \vert ) - {\tilde{μ}}_{joint}}{2 {\tilde{σ}}_{joint}} + \frac{( {\sum }_{c ∈ xyz} \vert {s}_{b} ( c ) - {s}_{a} ( c ) \vert ) - {\tilde{μ}}_{xyz}}{2 {\tilde{σ}}_{xyz}} + 0.5 \qquad ( 5 )$$

where J is the set of all joints of the robot, s(j) indicates the angular position of joint j, and s(c) indicates the Cartesian velocity of the robot base along world axis c. Here, the joint angles and Cartesian coordinates can be scaled separately since they have different units.

In various implementations, the goal is to jointly learn a policy π(a|s) and an approximate state-value V(s), from a dataset consisting of expert demonstrations and policy evaluations, where the policy replicates the expert actions and the state value approximates the average discounted returns. Using a Bayesian Imitation Learning method, the system can combine a stochastic state encoder network p(z|s) with two decoder networks: an action decoder qₐ(a|z) and a value decoder qᵥ(v|z).

In some implementations, the system can learn a policy that will replicate the expert actions, by applying a Huber loss between the demonstrated actions a and predictions â obtained through Monte Carlo sampling from a neural network decoder, as the Behavioral Cloning loss:

$${ℒ}_{BC} = {𝔼}_{z \sim p ( z \vert s )} [ {𝔼}_{\hat{a} \sim {q}_{a} ( \hat{a} \vert z )} [ {ℒ}_{Huber} ( a - \hat{a} ) ] ] \qquad ( 6 )$$

where a∈ [symbol] is the action command that includes: 2 DoF for the robot base, 9 DoF for the robot arm, and 1 DoF for the task termination prediction. In some implementations, the Behavioral Cloning loss is only applied to training instances that are expert demonstrations, e.g. evaluation instances from previous policies are not used for policy learning.

With the discounted returns G_{τ}(s) available from policy evaluation, state values in the discrete-state context can be computed by averaging the discounted returns over each time the state is visited, where Ts is the set of trajectories that visit state s:

$$V ( s ) = \frac{1}{\vert {T}_{s} \vert} {\sum }_{τ ∈ {T}_{s}} {G}_{τ} ( s ) \qquad ( 7 )$$

However, since the state representation (RGB or depth images) is continuous, each state s appears typically in exactly one trajectory; but, the system wants the learned state value information to be shared between similar states. To this end, the system can use the stochastic value decoder qᵥ(v|s), and the system can apply a Huber loss between Monte Carlo samples of predicted values and the discounted returns computed through policy evaluation:

$${ℒ}_{{V}_{π}} = {𝔼}_{z \sim p ( z \vert s )} [ {𝔼}_{\tilde{v} \sim {q}_{ν} ( \hat{v} \vert z )} [ {ℒ}_{Huber} ( v - \hat{v} ) ] ] \qquad ( 8 )$$

Training instances both from human demonstrations and on-policy operations are used when computing this loss. The former includes only successful runs while the latter contains both successful and failed episodes.

To discourage the model from overfitting, some implementations include applying the Variational Information Bottleneck on the learned stochastic encoding z. [symbol] _{BC} and [symbol] ᵥ_{_{π′}} together encourage z to be maximally predictive of a and v, respectively, and to encourage it to be minimally informative of s, the system can apply a Kullback-Leibler divergence loss [symbol] _{KL} between the state embedding posterior p(z|s) and the learned prior r(z). Due to the computational intractability of computing the KL divergence directly, the system can use Monte Carlo sampling to draw samples from both distributions and compute the sample divergences instead.

In some implementations, to achieve multiple objectives at once, the system can combine the losses into a single loss, weighted by two parameters, λ to control the policy/value learning tradeoff, and β to control the bottlenecking tradeoff:

$$ℒ = {ℒ}_{BC} + λ {ℒ}_{VA} + β {ℒ}_{KL} \qquad ( 9 )$$

For example, the system can use λ=0.5 and β=10⁻⁶.

In some implementations, the system can use a multivariate Gaussian distribution on [symbol] as the stochastic encoder p(z|s), parameterized by a ResNet-18 convolutional network that outputs the mean and covariance of the distribution. The action decoder qₐ(a|z) is a 2-layer MLP and the value decoder qᵥ(v|z) a 3-layer MLP. The learned prior r (z) is a multivariate Gaussian mixture with 512 components and learnable parameters.

In some implementations, the system is able to output the policy action at and the state value V(sₜ) given a state sₜ. In some implementations, various criteria can be used to decide when to ask for help: If the state value V(sₜ)<∈, for some constant ∈, for more than some constant v past frames, the system stops and asks for help. Otherwise, the system continues executing at, observing sₜ₊₁, and re-evaluating the asking-for-help criteria.

For operational deployment, the system can tune the thresholds E and v by running the value estimate on rollouts from the (human-labelled) validation set, computing the episode-level confusion matrix across different values of ∈ and v, and picking appropriate values such that the model satisfies requirements in terms of both overall precision and recall, as well as being able to correctly flag a small, hand-selected sample of failures of concern.

In some implementations, the model can be trained using a real-world dataset of ~2900 expert demonstrations and bootstrap the value estimate with ~9000 episodes of policy rollouts under a fully-supervised human operator setting. In some implementations, all expert demonstrations were success cases, whereas each of the policy rollouts was manually labelled as success or failure at the end of the episode, and discounted rewards for each step can be calculated offline post-factum. The policy rollouts were executed and labelled in a span of multiple months using 100+ different Behavioral Cloning models each independently trained with the action decoder head only. In a variety of implementations, the system can use 100% of the expert demonstrations and 75% of the policy rollouts to train the proposed BCVA model. Additionally or alternatively, the system can use the remaining 25% as a held-out validation dataset to evaluate model performance. In some implementations, a variety of different distance functions can be used to compute the discounted return: such as time, movement, pixel, one or more additional or alternative distance functions, and/or combinations thereof.

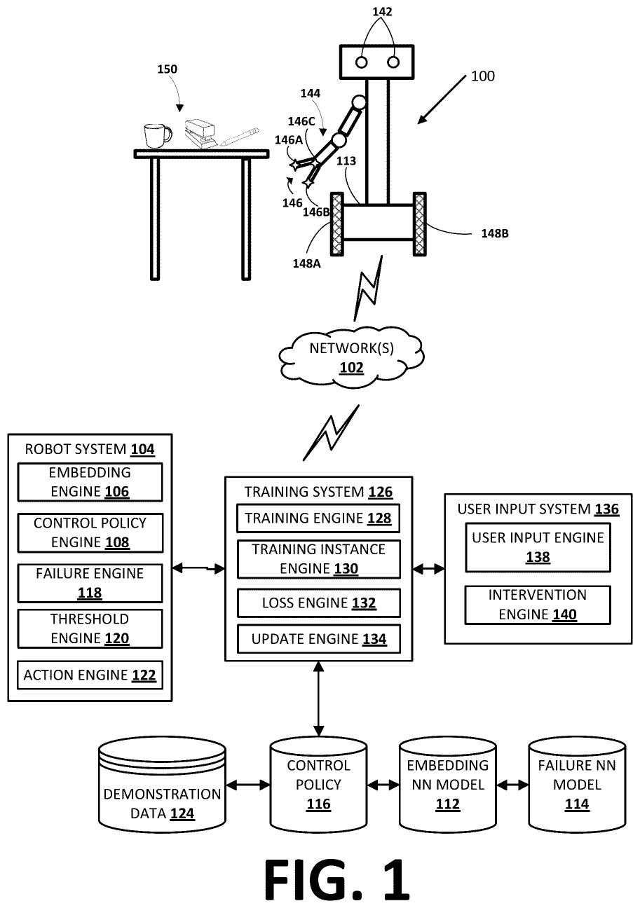

Turning now to the figures, FIG. 1 illustrates an example environment in which implementations related to training failure neural network (NN) models can be implemented. The example environment includes a robot 100, a robot system 104, a training system 126, and a user input system 136. One or more of these components of FIG. 1 can be communicatively coupled over one or more networks 102, such as local area networks (LANs), wide area networks (WANs), and/or any other communication network. The environment also a non-limiting example of a failure NN model 114, an embedding NN model 112, and a control policy 116.

The robot 100 illustrated in FIG. 1 is a particular real-world mobile robot. However, additional and/or alternative robots can be utilized with techniques disclosed herein, such as additional robots that vary in one or more respects from robot 100 illustrated in FIG. 1. For example, a stationary robot arm, a mobile telepresence robot, a mobile forklift robot, an unmanned aerial vehicle (UAV), and/or a humanoid robot can be utilized instead of or in addition to robot 100, in techniques described herein. Further, the robot 100 may include one or more engines implemented by processor(s) of the robot and/or by one or more processor(s) that are remote from, but in communication with, the robot 100.

The robot 100 includes one or more vision components that can generate instances of vision data (e.g., images, point clouds, etc.) related to shape, color, depth, and/or other features of object(s) that are in the line of sight of the vision components. The instances of the vision data generated by one or more of the vision components can for some or all of state data (e.g., environmental state data and/or robot state data). The robot 100 can also include position sensor(s), torque sensor(s), and/or other sensor(s) that can generate data and such data, or data derived therefrom, can form some or all of state data (if any). Additionally or alternatively, one or more vision components that can generate the instances of the vision data may be located external from the robot.

One or more of the vision components 142 may be, for example, a monocular camera, a stereographic camera (active or passive), and or a light detection and ranging (LIDAR) component. A LIDAR component can generate vision data that is a 3D point cloud with each of the points of the 3D point cloud defining a position of a point of a surface in 3D space. A monocular camera may include a single sensor (e.g., a charge-coupled device (CCD)), and generate, based on physical properties sensed by the sensor, images that each include a plurality of data points defining color values and/or grayscale values. For instance, the monocular camera may generate images that include red, blue, and/or green channels. A stereographic camera may include two or more sensors, each at a different vantage point, and can optionally include a projector (e.g., infrared projector). In some of those implementations, the stereographic camera generates, based on characteristics sensed by the two sensors (e.g., based on captured projection from the projector), images that each includes a plurality of data points defining depth values and color values and/or grayscale values. For example, the stereographic camera may generate images that include a depth channel and red, blue, and/or green channels.

The robot 100 also includes a base 113 with wheels 148A, 148B provided on opposed sides thereof for locomotion of the robot 100. The base 113 may include, for example, one or more motors for driving wheels 148A, 148B of the robot 100 to achieve a desired direction, velocity, and/or acceleration of movement for the robot 100.

The robot 100 also includes one or more processors that, for example provide control commands to actuators and/or other operation components thereof (e.g., control policy engine 108 as described herein). The robot 100 also includes robot arm 144 with end effector 146 that takes the form of a gripper with two opposing “fingers” or “digits” 146A, 146B. Additional and/or alternative end effectors can be utilized, or even no end effector. For example, alternative grasping end effectors can eb utilized that utilize alternate finger/digit arrangements, that utilize suction cup(s), (e.g., in lieu of fingers/digits), that utilize magnet(s) (e.g., in lieu of fingers/digits), etc. Also, for example, a non-grasping end effector can be utilized such as end effector that includes a drill, an impacting tool, etc.

A robotic control policy 116 can be initially trained based on human demonstrations of various robotic tasks. As the human demonstrations are performed, demonstration data can be generated via the user input system 136, and can be stored in demonstration database 124. The demonstration data can include, for example, instances of vision data generated by one or more of the vision components 142 during the performance of a given human demonstration of a given robotic task, state data of the robot 100 and/or the environment corresponding to the instances of the vision data captured during the given human demonstration of the given robotic task, corresponding sets of values for controlling respective components of the robot 110 corresponding to the instances of the vision data captured during the given human demonstration. For example, user input engine 138 can detect user input to control the robot 100, and intervention engine 140 can generate the corresponding sets of values for controlling the respective components of the robot 100. The corresponding sets of values utilized in controlling a respective component of the robot 100 can be, for example, a vector that describes a translational displacement and/or rotation (e.g., a sine-cosine encoding of the change in orientation about an axis of the respective component) of the respective component, lower-level control command(s) (e.g., individual torque commands that control corresponding actuator(s) of the robot 100, individual joint angles of component(s) of the robot, etc.), binary values for component(s) of the robot (e.g., indicative of whether a robot gripper should be opened or closed), other values for component(s) of the robot (e.g., robot arm movement, robot base movement, etc.), and/or other values that can be utilized to control the robot 100.

In some implementations, a human (or user) can utilize one or more computing device or input devices thereof (not depicted) to control the robot 100 to perform the human demonstrations of the robotic task. For example, the user can utilize a controller associated with the computing device to control the robot 100, an input device associated with an additional computing device, or any other input device of any computing device in communication with the robot 100, and the demonstration data can be generated based on the instances of the vision data captured by one or more of the vision components 142, and based on the user control of robot 100. In additional or alternative implementations, the user can physically manipulate the robot 100 or one or more components thereof (e.g., the base 113, the robot arm 144, and/or other components). For example, the user can physically manipulate the robot arm 144, and the demonstration data can be generated based on the instances of the vision data captured by one of the vision components 142, and based on the physical manipulation of the robot 100. The user can repeat this process to generate demonstration data for performance of various robotic tasks.

In some implementations, the human demonstrations can be performed in a real-world environment of the robot 100. For example, in the environment depicted in FIG. 1, the user can control the robot 100 to perform a motion task by causing the robot 100 to traverse towards a table, and perform a grasping task by causing the robot 100 to pick up an object 150 on the table. In additional or alternative implementations, the human demonstrations can be performed in a simulated environment using a simulated instance of the robot 100 via a robotic simulator (not depicted).

Robot system 104 can include embedding engine 106, control policy engine 108, failure engine 118, threshold engine 120, action engine 122, one or more additional or alternative engines, and/or combinations thereof. Embedding engine 106 can process one or more instances of vision data (e.g., data captured via one or more vision sensors 142) can be processed using embedding NN model 112 to generate an embedding. For example, the embedding can be a stochastic embedding that parameterizes the means and covariances of a multivariate distribution over possible embeddings. Control policy engine 108 can process one or more embeddings (e.g., embeddings generated using embedding engine 106) using control policy 116 to generate action output indicating one or more actions for one or more components of the robot to perform. In some implementations, action engine 122 can process the action output to generate control commands to control one or more components of the robot.

Additionally or alternatively, failure engine 118 can process the embedding (e.g., the embedding generated using embedding engine 106) using failure NN model 114 to generate failure output indicating the likelihood the robot will fail performance of the robotic task. In some implementations, the same embedding, generated based on the same instance of vision data can be processed using the failure NN model 114 and the control policy 116. In some implementations, threshold engine 120 can determine whether the failure output, generated using failure engine 118, satisfies a threshold value indicating the likelihood of a failure.

In some implementations, a user can utilize one or more computing devices (not depicted), the training system 126, the user input system 136, and the robot system 104 to train a robotic control policy for controlling the robot 100 in performance of various robotic tasks, to train the failure NN model 114 for determining the likelihood the robot 100 will fail in performance of the various robotic tasks, and/or to train the embedding NN model 112 to generate an embedding based on vision data captured in the environment of the robot. The robotic control policy can correspond to one or more machine learning (ML) models and a system that utilizes output, generated using the one or more ML models, in controlling the robot system 104 and/or various engines thereof. As described herein, the techniques described herein relate to training and refining robotic control policies and/or failure NN models using imitation learning techniques.

In particular, the robotic control policy can initially be trained based on demonstration data 124 (e.g., demonstration data stored in a database) and that is based on human demonstrations of various robotic tasks. Further, and subsequent to the initial training, the robotic control policy can be refined based on human interventions that are received during performance of various robotic tasks by the robot 100. Moreover, and subsequent to the refining, the robotic control policy can be deployed for use in controlling the robot 100 during future robotic tasks. Similarly, the embedding NN model 112 and/or the failure NN model 114 can be trained based on the demonstration data 124, refined based on human interventions that are received during performance of various robotic tasks, and used in controlling the robot 100 during future robotic tasks.

As noted above, a robotic control policy, a failure NN model, and/or an embedding NN model can be initially trained based on human demonstrations of various robotic tasks. As the human demonstrations are performed, demonstration data can be generated via the user input system 136, and can be stored as demonstration data 124. The demonstration data can include, for example, instances of vision data generated by one or more of the vision components 142 during performance of a given human demonstration of a given robotic task, state data of the robot 100 and/or the environment corresponding to the instances of the vision data captured during the given human demonstration of the given robotic task, corresponding sets of values for controlling respective components of the robot 100 corresponding to the instances of the vision data captured during the human demonstration. For example, user input engine 138 can detect user input to control the robot 100, and intervention engine 140 can generate the corresponding sets of values for controlling the respective components of the robot 100. The corresponding sets of values utilized in controlling a respective component of the robot 100 can be, for example, a vector that describes a translational displacement and/or rotation (e.g., a sine-cosine encoding of the change in orientation about an axis of the respective component) of the respective component, lower-level control command(s) (e.g., individual torque commands that control corresponding actuator(s) of the robot 100, individual joint angles of component(s) of the robot, etc.), binary values for component(s) of the robot (e.g., indicative of whether a robot gripper should be opened or closed), other values for component(s) of the robot 100 (e.g., indicative of an extend to which the robot gripper 146 should be opened or closed), velocities and/or accelerations of the component(s) of the robot 100 (e.g., robot arm movement, robot base movement, etc.), and/or other values that can be utilized to control the robot 100.

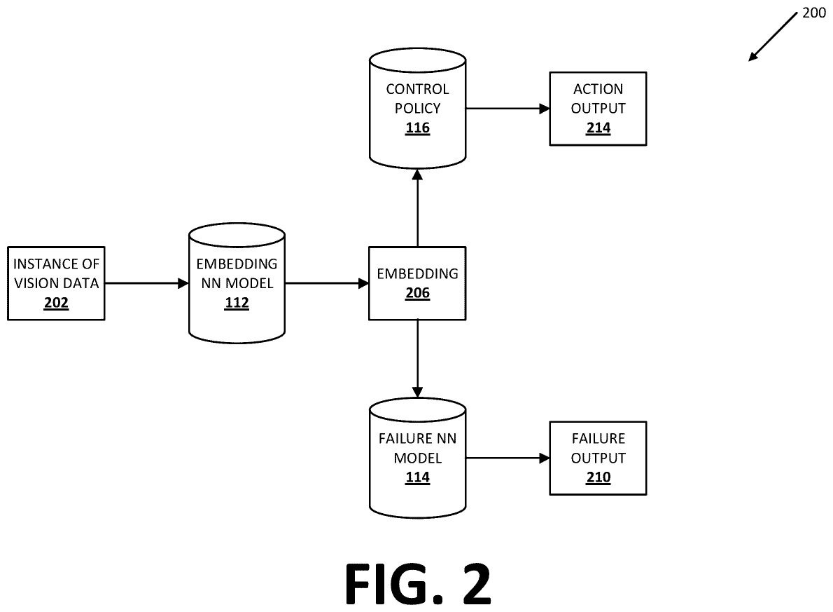

FIG. 2 illustrates an example 200 of generating failure output and/or action output in accordance with various implementations described herein. Example 200 includes processing an instance of vision data 202 using an embedding NN model 112 to generate an embedding 206. In some implementations, the instance of vision data can be captured via one or more vision sensors of the robot such as (but not limited to) one or more cameras, one or more RBG cameras, one or more depth cameras, one or more additional or alternative sensors, and/or combinations thereof. In some implementations, the vision sensor(s) can be affixed to the robot. For example, one or more cameras can be mounted onto the robot to capture vision data of the environment of the robot. Additionally or alternatively, the vision sensor(s) can be fixed to object(s) in the environment of the robot. For example, a camera can be affixed to a wall in the environment with the robot, to an additional robot in the environment, to one or more stationary objects in the environment, to one or more mobile objects in the environment, and/or combinations thereof. In some implementations, vision data can be captured via vision sensors affixed to the robot and to object(s) in the environment of the robot. For example, vision data can be captured via one or more vision sensors 142 of robot 100 as described herein with respect to FIG. 1.

In some implementations, the embedding 206 can be a stochastic embedding that parameterizes a distribution. For example, the stochastic embedding can parameterize the means and covariances of a multivariate distribution over possible embeddings. In some implementations, embedding 206 can be processed using robot control policy 116 to generate action output 214. Action output can include one or more corresponding actions to be performed by each of one or more components of the robot. For example, the action output can include action(s) for a robot base, one or more robot arms, one or more end effectors, etc.

Additionally or alternatively, embedding 206 can be processed using a failure NN model 114 to generate failure output 210. In some implementations, the failure output 210 can indicate a likelihood of the robot failing to perform the robotic task immediately and/or at some point in the future. In some implementations, the failure output can be used to determine the likelihood the robot will fail performance of the robotic task prior to processing the embedding using the robotic control policy to generate the action output.

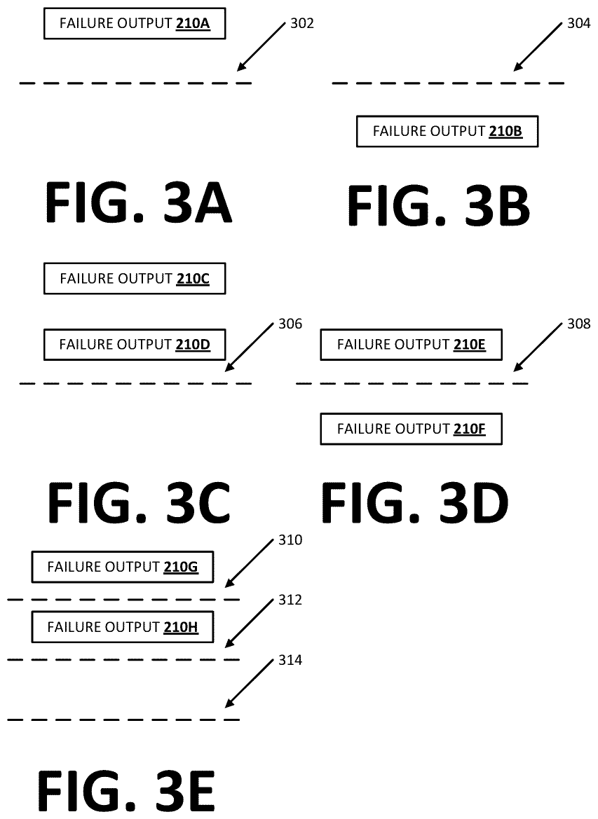

FIGS. 3A-3E illustrate examples of determining whether failure output satisfies a threshold in accordance with various implementations. FIG. 3A includes failure output 210A and a threshold likelihood value 302. In some implementations, the system can determine whether failure output 210A satisfies the threshold likelihood value 302 based on whether the failure output is larger than the threshold likelihood value, is smaller than the threshold likelihood value, is equal to the threshold likelihood value, is based on one or more additional or alternative comparisons with the threshold likelihood value, and/or combinations thereof. For example, the system can determine failure output 210A satisfies the threshold likelihood value 302 thus indicating the robot will fail in performance of the robotic task.

Similarly, FIG. 3B illustrates an example of failure output 210B and threshold likelihood value 304. In FIG. 3B, the system determines failure output 210B does not satisfy the threshold likelihood value 304. In some implementations, the system can determine whether the robot will fail the task based on processing several instances of failure output.

FIG. 3C illustrates a threshold likelihood value 306, a first instance of failure output 210C, and a second instance of failure output 210D. In some implementations, the first instance of failure output 210C can be generated based on processing a first instance of vision data captured while a robot is performing a given task. Similarly, the second instance of failure output 210C can be generated based on processing a second instance of vision data captured while the robot is performing the given task.

In some implementations, the first instance of vision data can precede the second instance of vision data. For example, the first instance of vision data can capture the robot prior to performing one or more actions for the given task, and the second instance of vision data can capture the robot performing the task 10 second after the first instance. In some implementations, the first instance of vision data can be captured immediately prior to the second instance of vision data.

In some implementations, the system can determine the robot will fail the task based on whether multiple instances of failure output 210 satisfy a threshold value. For example, the system can determine the first instance of failure output 210C and the second instance of failure output 210D both satisfy the threshold likelihood value 306, thus the system can determine the robot will fail performance of the task.

In contrast, FIG. 3D illustrates a first failure output 210E, a second failure output 210F, and a threshold likelihood value 308, where the first failure output 210E satisfies the threshold likelihood value 308, but the second failure output 210F dies not satisfy the threshold likelihood value 308. In some implementations, the system will not determine the robot will fail the task based on the first failure output 210E satisfying the threshold likelihood value 308 while the second failure output 210F does not satisfy the threshold likelihood value 308.

Additionally or alternatively, the threshold likelihood value utilized by the system in determining whether the robot will fail performance of the robotic task can be determined based on one or more factors. FIG. 3E includes a first failure output 210G, a second failure output 210H, a first threshold likelihood value 310, a second threshold likelihood value 312, and a third threshold likelihood value 314. For example, the system can select a given threshold value from a plurality of threshold likelihood values based on the status of a computing device (e.g., the computing a device for a user to intervene with the performance of the robotic task). Additionally or alternatively, the system can select a threshold value based on whether one or more objects are detected in the environment of the robot. Objects can include stationary objects (doors, walls, tables, doorknobs, etc.), one or more objects for the robot to manipulate (e.g., a tool for the robot to manipulate with an end effector), one or more mobile objects (e.g., one or more additional robots, one or more people, etc.)

Similarly, the system can select a threshold value based on whether one or more objects are detected within a threshold distance of the robot. The example illustrated in FIG. 3E includes failure output 210G satisfying the first threshold likelihood value 310, the second threshold likelihood value 312, and the third threshold likelihood value 314. However, second failure output 210H does not satisfy the first threshold likelihood value 310 while second failure output 210H does satisfy the second threshold likelihood value 312 and the third threshold likelihood value 314.

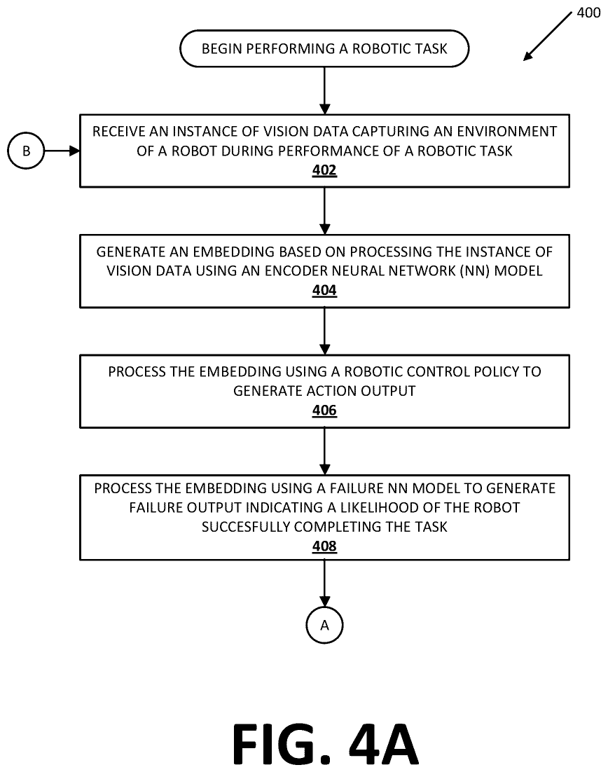

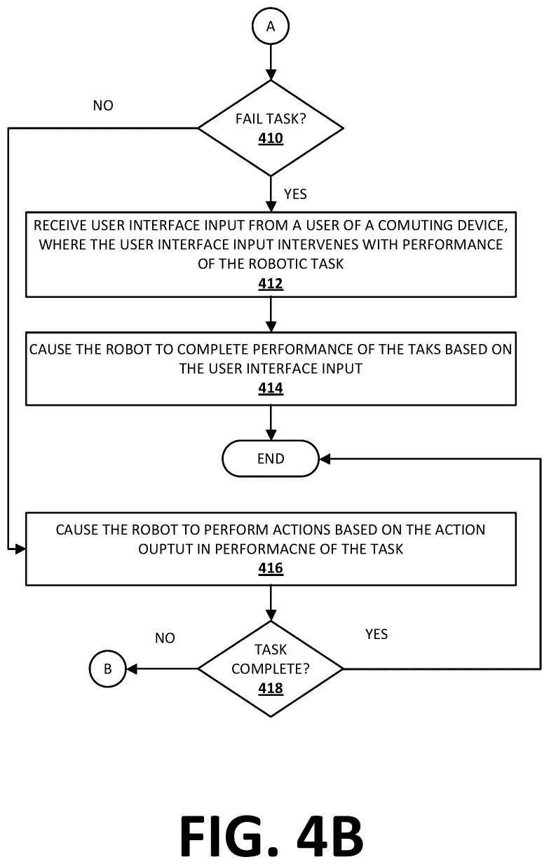

FIGS. 4A-4B are a flowchart illustrating an example process 400 in accordance with a variety of implementations described herein. For convenience, the operations of the process 400 is described with reference to a system that performs the operations. This system may include one or more processors, such as processor(s) of robot 100, robot 525 and/or computing system 610. Moreover, while operations of process 400 are shown in a particular order, this is not meant to be limiting. One or more operations may be reordered, omitted and/or added.

At block 402, the system begins performing a robotic task. In some implementations, the system can receive an instance of vision data capturing an environment of a robot during performance of the robotic task. For example, the robot can receive an instance of vision data captured by one or more vision sensors 142 of robot 100 as described herein with respect to FIG. 1.

At block 404, the system generates an embedding based on processing the instance of vision data using an encoder neural network (NN) model. For example, the system can use embedding engine 106 of robot 100 to process the instance of vision data using embedding NN model 112 to generate the embedding as described herein with respect to FIG. 1.

At block 406, the system processes the embedding using a robotic control policy to generate action output. For example, the system can use control policy engine 108 of robot 100 to generate the action output as described herein with respect to FIG. 1.

At block 408, the system processes the embedding using a failure NN model to generate failure output. In some implementations, the failure output indicates a likelihood of the robot successfully completing the robotic task. For example, the system can use failure engine 118 of robot 100 to process the embedding using failure NN model 114 to generate the failure output as described herein with respect to FIG. 1.

At block 410, the system determines whether the failure output indicates the robot will fail performance of the robotic task. In some implementations, the system can determine, based on the failure output, the robot will fail performance of the robotic task based the action output. In some other implementations, the system can determine, based on the failure output, the robot will fail performance of the robotic task at some point in the future. If the system determines the failure output indicates the robot will fail performance of the robotic task, the system proceeds to block 412. If the system determines the failure output does not indicate the robot will fail performance of the robotic task, the system proceeds to block 416. For example, the system can use threshold engine 120 of robot 100 as described herein with respect to FIG. 1 in determining whether the failure output indicates the robot will fail performance of the robotic task.

At block 412, the system receives user interface input from a user of a computing device. In some implementations, the user interface input intervenes with performance of the robotic task. For example, the system can receive user interface input intervening with performance of the robotic task using user input engine 138 of robot 100 as described herein with respect to FIG. 1. Additionally or alternatively, the system can receive one or more instances of action output using intervention engine 140 of robot 100 described herein with respect to FIG. 1.

At block 414, the system causes the robot to complete performance of the robotic task based on the user interface input. Once completing the performance of the robotic task, the process ends.

At block 416, the system causes the robot to perform one or more actions based on the action output. In some of those implementations, the one or more actions can be in furtherance of the robot performing the robotic task. For example, the system can use action engine 122 of robot 100 as described herein with respect to FIG. 1 in performance of the one or more actions based on the action output.

At block 418, the system determines whether the robot has completed performance of the task. If so, the process ends. If the robot determines the robot has not completed performance of the robotic task, the system proceeds back to block 402, and receives an additional instance of vision data capturing the environment of the robot. In some implementations, the additional instance of vision data can reflect one or more actions performed by the robot in the pervious iteration. Subsequently, the process can proceed to blocks 404, 406, 408, 410, 412, 414, and 416 based on the additional instance of vision data.

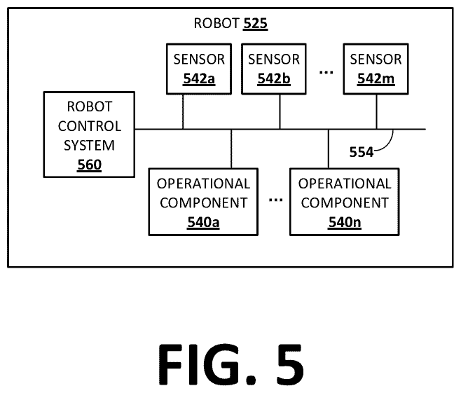

FIG. 5 schematically depicts an example architecture of a robot 520. The robot 520 includes a robot control system 560, one or more operational components 504a-n, and one or more sensors 508a-m. The sensors 508a-m can include, for example, vision components, pressure sensors, positional sensors, pressure wave sensors (e.g., microphones), proximity sensors, accelerometers, gyroscopes, thermometers, barometers, and so forth. While sensors 508a-m are depicted as being integral with robot 520, this is not meant to be limiting. In some implementations, sensors 508a-m may be located external to robot 520, e.g., as standalone units.

Operational components 504a-n can include, for example, one or more end effectors (e.g., grasping end effectors) and/or one or more servo motors or other actuators to effectuate movement of one or more components of the robot. For example, the robot 520 can have multiple degrees of freedom and each of the actuators can control actuation of the robot 520 within one or more of the degrees of freedom responsive to control commands provided by the robot control system 560 (e.g., torque and/or other commands generated based on action outputs from a trained action ML model). As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator can comprise providing the control command to a driver that translates the control command into appropriate signals for driving an electrical or mechanical device to create desired motion.

The robot control system 560 can be implemented in one or more processors, such as a CPU, GPU, and/or other controller(s) of the robot 520. In some implementations, the robot 520 may comprise a “brain box” that may include all or aspects of the control system 560. For example, the brain box may provide real time bursts of data to the operational components 504a-n, with each of the real time bursts comprising a set of one or more control commands that dictate, inter alia, the parameters of motion (if any) for each of one or more of the operational components 504a-n. In various implementations, the control commands can be at least selectively generated by the control system 560 based at least in part on final predicted action outputs and/or other determination(s) made using action machine learning model(s) that are stored locally on the robot 520, such as those described herein.

Although control system 560 is illustrated in FIG. 5 as an integral part of the robot 520, in some implementations, all or aspects of the control system 560 can be implemented in a component that is separate from, but in communication with, robot 520. For example, all or aspects of control system 560 may be implemented on one or more computing devices that are in wired and/or wireless communication with the robot 520, such as computing device 610 of FIG. 5.

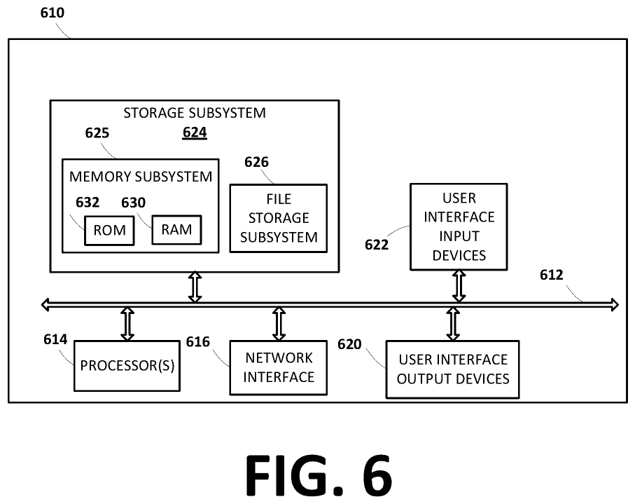

FIG. 6 is a block diagram of an example computing device 610 that can optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 826, user interface output devices 820, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 can include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of one or more methods described herein.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

1. A method implemented by one or more processors, the method comprising:
receiving an instance of vision data capturing an environment of a robot during performance of a robotic task by the robot, where the instance of vision data is captured via a vision component;
generating an embedding based on processing the instance of vision data using an encoder model, the encoder model being a trained neural network (NN) model;
processing the embedding using a robotic control policy to generate action output that indicates, for each of one or more components of the robot, a corresponding action to be performed by the component, the robotic control policy being a trained NN model;
processing the embedding using a failure NN model to generate failure output indicating a likelihood of the robot successfully completing the task;
determining, based on the failure output, whether the robot will fail in performance of the robotic task;
in response to determining the robot will fail in performance of the robotic task:
causing a user of a computing device to intervene in performance of the robotic task;
receiving, from the user and via the computing device, user interface input that intervenes with performance of the robotic task; and
causing the robot to complete performance of the task based on the user interface input.

2. The method of claim 1, wherein the robotic control policy is trained using imitation learning.

3. The method of claim 2, wherein the robotic control policy is a Behavior Cloning model.

4. The method of claim 1, wherein determining whether the robot will fail in performance of the robotic task based on the failure output comprises:
determining whether the failure output satisfies a threshold value.

5. The method of claim 1, wherein determining whether the robot will fail in performance of the robotic task based on the failure output comprises:
determining whether the failure output satisfies a threshold likelihood value; and
determining whether a previous failure output satisfies the threshold likelihood value, wherein the previous failure output was generated by processing a previous embedding using the failure model, and wherein the previous embedding was generated based on processing a previous instance of vision data captured by the vision component during the performance of the robotic task by the robot; and
determining whether the robot will fail in performance of the robotic task based on both whether the failure output satisfies the threshold likelihood value and whether the previous failure output satisfies the threshold likelihood value.

6. The method of claim 5, wherein the previous instance of vision data is an immediately preceding instance of vision data, captured most recently by the vision component relative to the instance of vision data, and wherein the previous embedding, generated based on the previous instance of vision data, is utilized in determining whether the robot will fail in performance of the robotic task based on the previous instance of vision data being the immediately preceding instance of vision data.

7. The method of claim 5, wherein the previous instance of vision data is captured by the vision component within a threshold amount of time relative to the instance of vision data, and wherein the previous embedding, generated based on the previous instance of vision data, is utilized in determining whether the robot will fail in performance of the robotic task based on the previous instance of vision data being captured within the threshold amount of time.

8. The method of claim 5, wherein the previous embedding was processed, using the robotic control policy to generate previous action output that indicated, for each of the plurality of components of the robot, a corresponding previous action to be performed by the component, and wherein the previous action were already implemented by the robot, or were being implemented by the robot, during processing the embedding using the failure NN model to generate the failure output.

9. The method of claim 5, wherein determining whether the robot will fail in performance of the robotic task based on both whether the failure output satisfies the threshold likelihood value and whether the previous failure output satisfies the threshold likelihood value, comprises:
determining that the robot will fail in performance of the task if either one of the failure output or the previous failure output fails to satisfy the threshold.

10. The method of claim 5, wherein determining whether the robot will fail in performance of the robotic task based on both whether the failure output satisfies the threshold likelihood value and whether the previous failure output satisfies the threshold likelihood value, comprises:
determining that the robot will fail in performance of the task only when both the failure output or the previous failure output satisfy the threshold.

11. The method of claim 1, wherein determining whether the robot will fail in performance of the robotic task based on the failure output comprises:
selecting, from a plurality of candidate thresholds, a particular threshold;
determining whether the failure output satisfies the selected particular threshold; and
determining whether the robot will fail in performance of the robotic task based on whether the failure output satisfies the selected particular threshold.

12. The method of claim 11, wherein selecting the particular threshold comprises:
determining a current status of availability of computing devices to intervene in robotic task performance; and
selecting the particular threshold based on the current status.

13. The method of claim 11, wherein selecting the particular threshold comprises:
selecting the particular threshold based on a category assigned to the robotic task that is being performed.

14. The method of claim 11, wherein selecting the particular threshold comprises:
selecting the particular threshold based on whether the robot has detected one or more particular types of objects in the environment.

15. The method of claim 11, wherein selecting the particular threshold comprises:
selecting the particular threshold based on whether the robot has detected one or more particular types of objects to be within a threshold distance of the robot.

16. The method of claim 1, wherein the computing device is in the environment of the robot.

17. The method of claim 1, wherein the computing device is remote from the robot and is not in the environment of the robot.

18-27. (canceled)

28. A method implemented by one or more processors of a robot, the method comprising:
receiving an instance of vision data capturing an environment of the robot during performance of a robotic task by the robot, where the instance of vision data is captured via one or more vision components of the robot;
generating an embedding based on processing the instance of vision data using an encoder model, the encoder model being a trained neural network (NN) model;
processing the embedding using a robotic control policy to generate action output that indicates, for each of a plurality of components of the robot, a corresponding action to be performed by the component;
processing the embedding using a failure NN model to generate failure output indicating a likelihood of the robot successfully completing the task;
determining, based on the failure output, whether the robot will fail in performance of the robotic task;
in response to determining that the robot will fail in performance of the robotic task:
halting performance of the task by the robot; and
in response to determining that the robot will not fail in performance of the robotic task:
continuing performance of the task by the robot, continuing performance of the task by the robot comprising:
causing implementation of the corresponding actions by the components of the robot.

29. The method of claim 28, further comprising:
in response to determining that the robot will fail in performance of the robotic task:
causing a prompt to be rendered via an interface of a computing device or the robot, the prompt requesting intervention in performance of the robotic task.

30. The method of claim 28, further comprising:
in response to determining that the robot will fail in performance of the robotic task:
transmitting, to a remote computing device, the vision data and/or additional vision data captured by at least one of the vision components; and
causing the robot to complete performance of the task based on user interface input received via the remote computing device responsive to the transmitting.
